(19) United States
(12) Patent Application Publication
(10) Pub. No.: US 2022/0000280 A1
(43) Pub. Date: Jan. 6, 2022

(54) APPARATUS FOR USE WITH A DISPLAY UNIT

(71) Applicant: Simon Tiwha Enterprises Pty Ltd, New South Wales (AU)

(72) Inventor: Jeffrey Simon, New South Wales (AU)

(21) Appl. No.: 17/291,331

(22) PCT Filed: Nov. 5, 2019
(86) PCT No.: PCT/AU2019/000139

§ 371 Date: May 5, 2021

(30) Foreign Application Priority Data
Nov. 5, 2018 (AU) 2018904208

(51) Int. Cl. A47F 3/08; A47F 3/06; A47F 3/00; A47F 5/00

(52) U.S. Cl. CPC A47F 3/085; A47F 5/0037; A47F 3/007; A47F 3/06

(57) ABSTRACT

The invention provides apparatus (410) suitable for use with a display unit (12). The apparatus (410) includes conveyor means which in one embodiment has a frame (448) with runners (450). An object (422) can be conveyed in a first direction from a first location (426) in the display unit (10) to a second location (428). Object (422) is suspended from runner (450) and movable between first location (426) and second location (428), using a pulley system activated via a handle (52). In another embodiment, the conveyor means may include a conveyor belt (24) driven by wheels (32) connected to a motor.

### TECHNICAL FIELD

The present invention broadly relates to apparatus suitable for use with a display unit and to a display unit containing such apparatus. In particular, this invention is concerned with apparatus capable of moving a displayed object from a first location to a second location.

### BACKGROUND OF THE INVENTION

Display units are commonly used in shops to display goods, often in circumstances where it is undesirable or inappropriate that the goods can be touched or picked up by a customer. Such a display unit commonly has a display cabinet with a glass front for customer viewing of displayed goods and an associated serving surface. The glass front may be below counter height, or above counter height, or partly below and partly above counter height. The glass front may be vertical or sloping away from the customer, for example. The associated serving surface may be above the glass front or behind it for instance.

An example of such a circumstance is a display unit used to display baked goods, such as cakes and tarts, or prepared food, where to maintain hygiene and/or prevent damage there needs to be a physical barrier between the goods and the customer. Baked goods are usually displayed in tiers and often also in rows. Once a customer has made a selection, the baked item must be manoeuvred out of its location to be packaged and handed over to the customer. In manoeuvring the item, the sales clerk may inadvertently damage or contaminate the selected item or another baked item in the same row or in an adjacent tier.

Another example of such a circumstance is where ingredients for making fresh sandwiches are displayed for selection by the customer so that a sandwich hand can prepare bespoke sandwiches. Here again, to maintain hygiene and/or prevent contamination of ingredients, a physical barrier is maintained between the customer and the ingredients. However, trays containing the ingredients are often set out in an array and when a sandwich hand is assembling the sandwich an ingredient may be accidentally dropped into a tray for another ingredient. This can be a problem: for instance, it is highly undesirable that beetroot juice drips into a tray containing curried egg.

A further example is a display unit used for goods of high or substantial value, or goods of small size, all of which may be susceptible to theft or damage.

An occupational hazard may arise when a server is bending and/or extending in an attempt to retrieve an item from a shelf in a display unit. Particularly when the item is heavy and at a low location in the unit, physiological damage can occur to the server.

In all such circumstances and especially where hygiene, contamination and prevention of damage to items and servers are concerned, there is a need for apparatus which facilitates movement of a displayed object from a first location to a second location.

It is therefore the object of the present invention to provide apparatus for use with a display unit which facilitates such movement. It is a further object of the invention to provide a display unit which includes such an apparatus.

### SUMMARY OF THE INVENTION

Accordingly, the present invention provides apparatus suitable for use with a display unit, the apparatus including conveyor means which is:
adapted to convey an object in a first direction from a first location in the display unit to a second location and
adapted to convey an object in a second direction from the second location to the first location.

The apparatus of the invention may be incorporated in the display unit as original equipment, or it may be retrofitted to an existing display unit. The display unit may be chosen from a wide range, including the types of display units referred to under ‘Background of the Invention’.

The conveyor means may be used to support one or more objects in the display. The conveyor means may be a substitute for a conventional array of trays or tiered display shelving, for example.

The conveyor means may be substantially flat, or it may be at least partially inclined. In one embodiment, the conveyor means is substantially flat at or near the second location.

In a preferred embodiment, the conveyor means includes a belt movable by a drive means, such as one or more motor driven supporting wheels or the like. The belt may have an upper surface of rubber or other material, which may be designed to have sufficient friction to retain the object, even when the first location is below the level of the second location, so that the object travels up a slope from the first location to the second location. In the event that there is to be a high gradient between the first location and the second location, the upper surface of the belt may include depressions or protrusions intended to maintain an object in place as it travels between the first location and the second location.

If preferred, the conveyor means may include lifting means, which may enable the object to be lifted above other objects on the movable belt, in order that the object may be located in a desired position, such as the second location.

In another embodiment, the conveyor means includes a pulley system capable of conveying the object between the first and second locations. In this embodiment, it is preferred that the object is suspended by the pulley system, so that the object may be moved in a substantially horizontal manner between the first and second locations.

In yet another embodiment, the conveyor means may be adapted to move the object in a substantially horizontal manner from the second location and then to display the object at an angle to the horizontal at the first location.

The first location is within the display unit and preferably is a location in which the object is displayed behind glass for sale or selection by a customer. The second location is preferably at or near a place which the object is dealt with after having been selected by the customer. For example, the second location may be at an upper or lower part of the display unit or near a counter on which the object is boxed or bagged for completion of sale. If the display unit contains ingredients for sandwich making, the second location may be at or near a counter for assembling a sandwich.

The object to be conveyed may be an item for sale or a container for such an item, including a tray. Included in such items are: bakery products, other foodstuff or goods of high or substantial value, goods of small size, or a tray which contains any of the foregoing or ingredients for sandwich making, etc.

In a preferred embodiment, the apparatus of the invention includes stop means which, if selected by a user or by default, stops the conveyor means when the object reaches the second location. The stop means may be any suitable stop means, including a trigger for disengaging drive means for the conveyor means.

In another preferred embodiment, the apparatus of the invention may be controlled by a computer software programme, so that the conveyor means is caused to stop automatically at a chosen point. An example of such a chosen point may occur when a leading edge of an object to be conveyed, such as a tray, reaches the second location or a location near it, such as point A.

Preferably, the apparatus of the invention includes means to reverse direction of the conveyor means, so that an object in the second location can be moved towards or to the first location.

The apparatus of the invention may be retrofitted to existing display units, as will be apparent to one skilled in the art. As an example, the apparatus of the invention may be installed in a display unit intended to display bakery products in a tiered arrangement of shelves. This type of display unit may have an inclined glass front or glass in another configuration. An example is a vertical glass front that joins a horizontal glass top. Larger items such as cakes are located on the lowest shelf of the tier and smaller items in stepped back shelves above the lowest shelf. The tiered shelves in this embodiment are replaced by the apparatus of the invention, the conveyor means having a belt which is inclined to match the inclined glass front. The belt has sufficient friction on its upper surface, or appropriate ridges, to keep each item in place during display.

If desired, two or more apparatus of the invention may be used in a single display unit, so that individual items may be moved from one location to another independently of neighbouring items. When two or more apparatus of the invention are used in a single display unit, the apparatus may be configured to move at the same time or independently. If independent movement is not required, the apparatus of the invention may be up to a similar width to that of the display unit.

If desired, instead of an inclined conveyor belt, the apparatus of the invention may have a frame or supports which enable tiered display of objects.

A further advantage of the apparatus of the invention is that less volume is required in a display unit, because there is no need for a worker to have room to manipulate items displayed over one another. (The need for room for this purpose is readily observed in a prior art tiered display unit.) As a consequence, display units in which an apparatus of the invention is installed, either as original equipment or as a retrofit, may have spare volume for storage. Ideally, the spare volume is located beneath the apparatus of the invention. The spare volume may be used to store extra stock or other items. In particular, if the display unit is refrigerated, the ability to use the extra volume for storage of temperature-sensitive stock is very efficient, since it makes use of space which is already cooled by the refrigeration mechanism.

### BRIEF DESCRIPTION OF THE DRAWINGS

The invention will now be described in connection with non-limiting embodiments thereof in connection with the drawings, in which:

FIG. 1 is a schematic side elevation of a first embodiment of the invention in a display unit;

FIG. 2 is a perspective view of a second embodiment of the invention;

FIGS. 3, 4 and 5 are side elevations of the embodiment of FIG. 2, illustrating movement of an object from a first location to a second location;

FIG. 6 is a top view of the embodiment of FIG. 2;

FIG. 7 shows a perspective view of a third embodiment of the invention;

FIGS. 8, 9 and 10 are side elevations of the embodiment of FIG. 7, illustrating movement of an object from a second location to a first location;

FIG. 11 is a front view of the embodiment of FIG. 7;

FIG. 12 is a perspective view of a fourth embodiment of the invention;

FIGS. 13, 14 and 15 are side elevations of the embodiment of FIG. 12, illustrating movement of an object from a first location to a second location;

FIG. 16 is a top view of the embodiment of FIG. 12; and

FIG. 17 is a front view of the embodiment of FIG. 12.

It will be appreciated that the drawings are not all to the same scale.

### DETAILED DESCRIPTION OF PREFERRED EMBODIMENTS

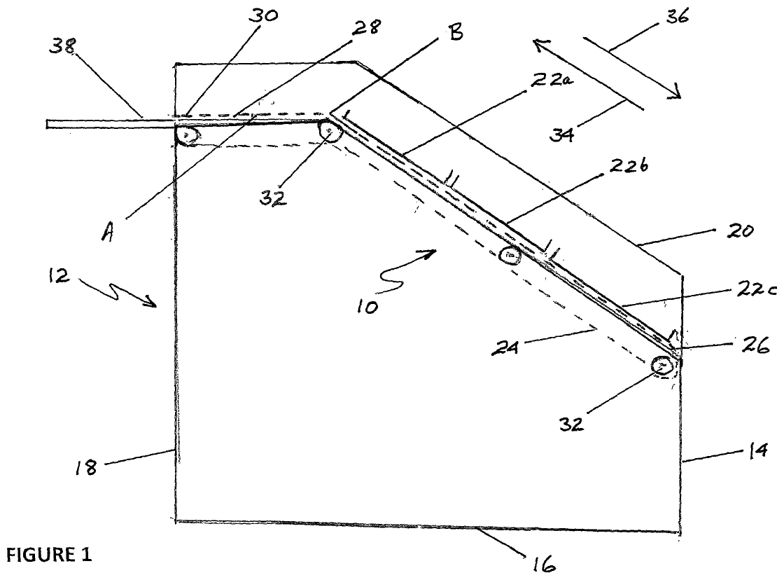

Referring first to FIG. 1, apparatus 10 is shown in place in display unit 12 which has a customer front side 14, a floor 16 and a server rear side 18. Glass 20 allows a customer to view objects (not shown) in trays 22a, 22b and 22c.

Apparatus 10 has conveyor means which includes belt 24 extending between first location 26 in display unit 12 to second location 28. Belt 24 is inclined at about 45 degrees to floor 16, except at second location 28, where belt 24 is substantially horizontal. Belt 24 has a top surface 30 made of rubber or a rubber substitute, with sufficient friction so that each of trays 22 remains in position when belt 24 conveys trays 22 between first location 26 and second location 28.

A motor (not shown) drives wheels 32 (some only are labelled) in a desired direction, either first direction 34 or second direction 36, as indicated by arrows 34 and 36, respectively. The motor may be activated by a switch (not shown), conveniently under counter 38. Counter 38 preferably runs the length of rear server side 18

In a variation, belt 24 may have a more gradual transition from the slope shown in FIG. 1, to second location 28. For example, one or more extra drive wheels may be located around transition point B to support belt 24 around a curve at that point.

In this embodiment, apparatus 10 has automatic stop means (not shown) which stops or pauses the motor as soon as tray 22a reaches and lies flat on second location 28. In another embodiment, the stop means may be triggered when a leading edge of tray 22a reaches point A shown in FIG. 1. Point A is calculated so that once tray 22a on belt 24 reaches point A, and the conveyor means is stopped, tray 22a is sufficiently advanced to second location 28 that the leading edge drops down through gravity and tray 22a comes to rest on second location 28.

If the item in tray 22a is the item desired for sale, the server may pull the item onto counter 38 into a box or bag and transfer it to the customer. If it is the item in tray 22b that is required for sale, the server removes tray 22a and places it on counter 38 but to one side. The server then activates the motor in direction 34. When tray 22b reaches and lies flat on second location 28, the motor again stops automatically. The server then pulls tray 22b onto counter 38, places the item into a box or bag and transfers it to the customer.

The above steps may be repeated if it is the item in tray 22c which is required.

Once the customer has been served, the motor is activated to move belt 24 in direction 36, any unsold items being replaced into empty trays 22, or the trays themselves being replaced, and the motor being paused as required to ensure orderly transfer of unsold items into display unit 12.

Display unit 12 in this embodiment has apparatus 10 included as original equipment.

If desired, space under apparatus 10 may be used to store stock prior to display, or to store other items.

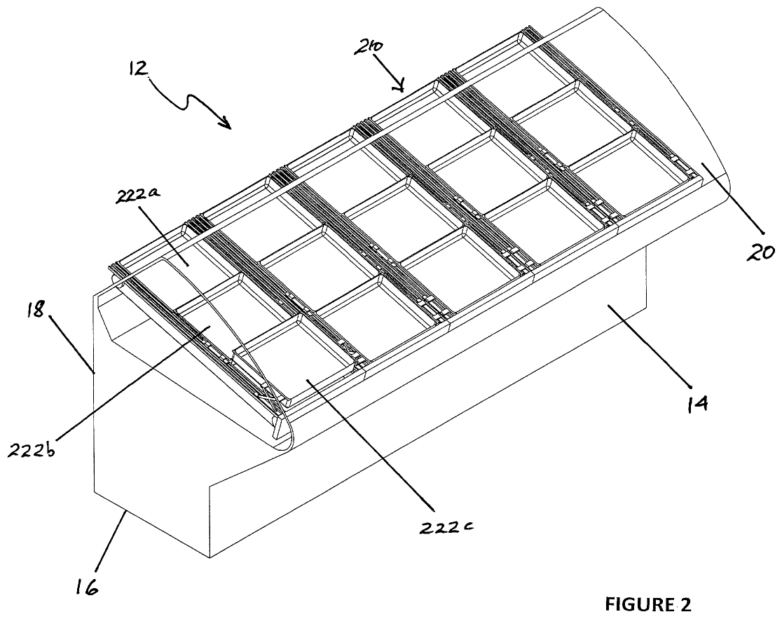

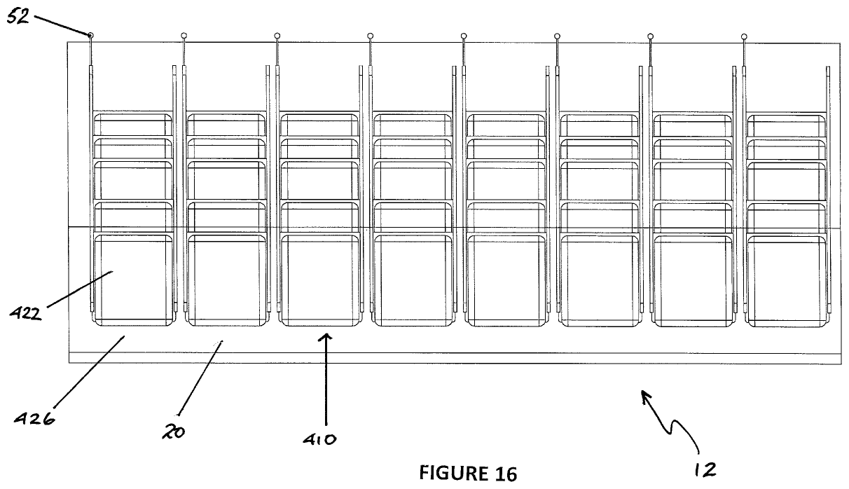

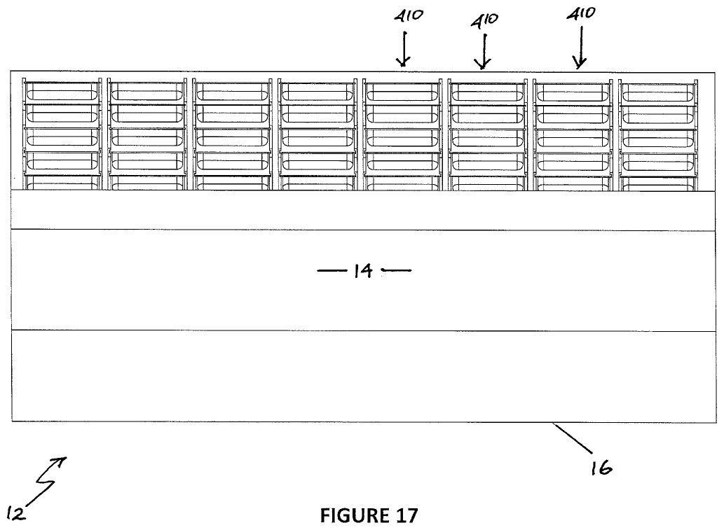

In relation to the further embodiments in FIGS. 2 to 17, the same labels are used to denote the same or similar parts of the display unit itself. Similar trays and similar parts of the apparatus of the invention are labelled with a prefix 2 for the second embodiment, the prefix 3 for the third embodiment and the prefix 4 for the fourth embodiment.

Turning now to the second embodiment in FIGS. 2 to 6, as shown in FIG. 2, display unit 12 has a customer front side 14, a floor 16 and a server rear side 18. Glass 20 allows a customer to view objects (not shown) in trays 222a, 222b and 222c.

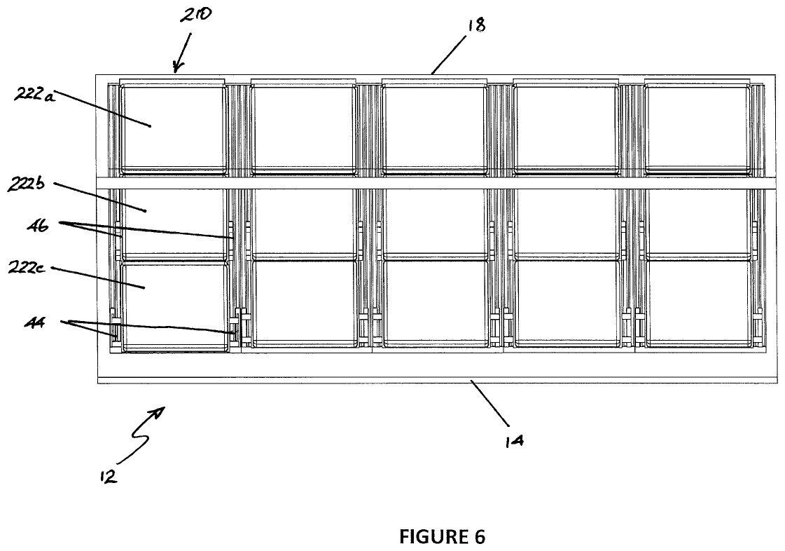

As seen in FIGS. 2 and 6, five identical versions of apparatus 210 have been installed in display unit 12, side by side, each apparatus 210 being operable independently.

Apparatus 210 has conveyor means which includes belt 224 extending between first location 26 in display unit 12 to second location 28. Belt 224 is inclined at about 30 degrees to floor 16. Shelf 38 may be present as in the first embodiment in FIG. 1, but is not depicted for convenience. Belt 224 may have a top surface 30 made of rubber or a rubber substitute, with sufficient friction so that each of trays 222 remains in position when belt 224 conveys trays 222 between first location 26 and second location 28. However, it is to be noted that the angle of inclination of belt 224 is less than that of belt 24 in FIG. 1 and less friction may be required to keep tray 222 in position.

The manner of operation of belt 224 is much the same as that of belt 24, except as described below. Panel 40 on server rear side 18 contains buttons 42 for operating the motor and for moving trays.

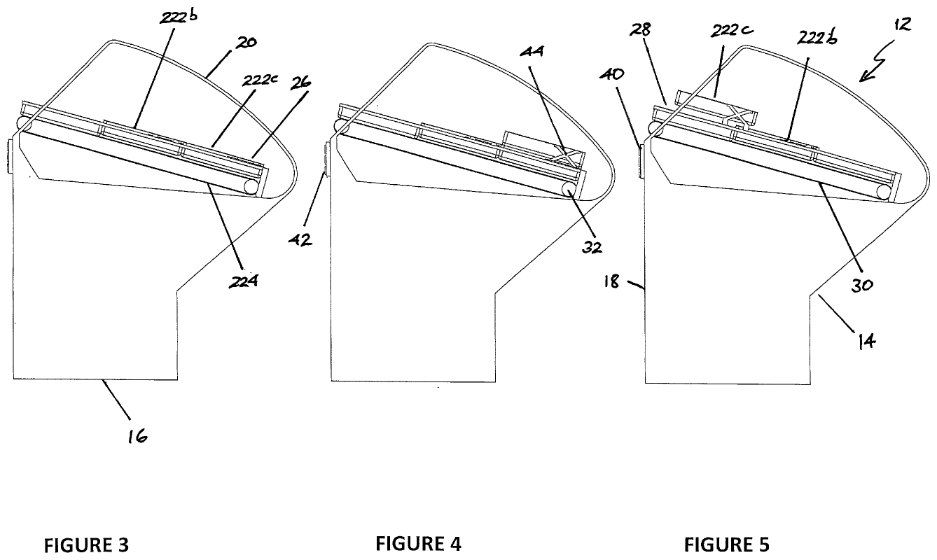

In FIG. 3, tray 222a has been removed by the server, who desires to move tray 222c from the first position shown in FIG. 2 to the second position previously occupied by tray 222a. The server operates the appropriate button 42 which activates scissor lift 44 (FIG. 4) to elevate tray 222c above tray 222b. Scissor lift 44 is connected to belt 224, so that rotation of wheels 32 causes scissor lift 44 and tray 222c to move from first location 26 (FIG. 3) to second location 28 (FIG. 5), where tray 222c may be lowered into location 28 by deactivation of scissor lift 44.

Preferably, a scissor lift 44 is located on each side of tray 222c for stability.

Once the contents of tray 222c have been removed or supplemented or treated as desired, the motor may be activated so that tray 222b is moved to location 26, where scissor lift 44 may engage tray 222b as required.

Optionally, a second set of scissor lifts 46 may be installed for tray 222b, as seen in FIG. 6.

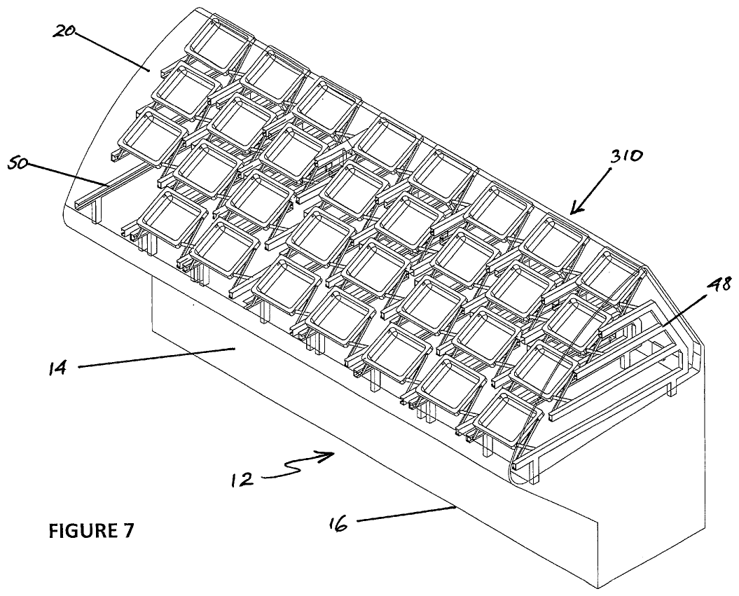

In the third embodiment in FIGS. 7 to 11, there are eight identical versions of apparatus 310 installed in display unit 12, side by side, each apparatus 310 being operable independently.

Apparatus 310 does not have a conveyor belt as in the first and second embodiments. Instead, apparatus 310 has a frame 48 which includes horizontal runners 50a to 50d, along which scissor lifts 344 are designed to travel in response to activation of the motor via a button on panel 40.

Frame 48 provides four tiers of trays 322a to 322d, as shown in FIGS. 7 to 11. There is no requirement for shelf 38, because second location 328 is positioned at the server side of frame 310, although a serving shelf 38 may be included if desired, ideally at the level of runners 50d.

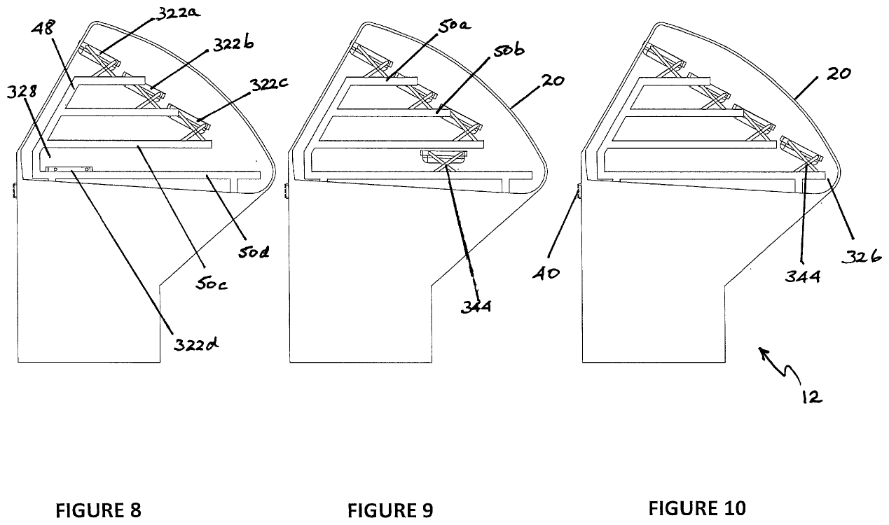

In FIG. 8, tray 322d is shown at rest at second location 328. In FIG. 9, scissor lifts 344 have elevated tray 322d and have moved along runners 50d towards first location 326 (FIG. 10). Once tray 322d reaches first location 326, the motor causes scissor lifts 344 to tilt tray 322d towards glass 20 on the display side of display unit 12, as shown in FIG. 10.

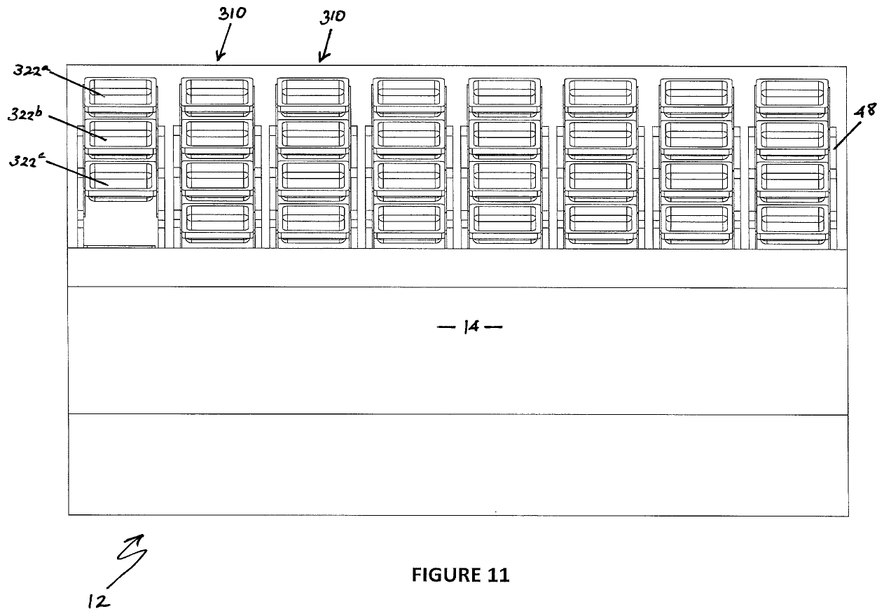

FIG. 8 corresponds to FIG. 7, except that tray 322d, being at second location 328, is not visible in FIG. 7. Tray 332d has been removed from second location 328 in FIG. 11.

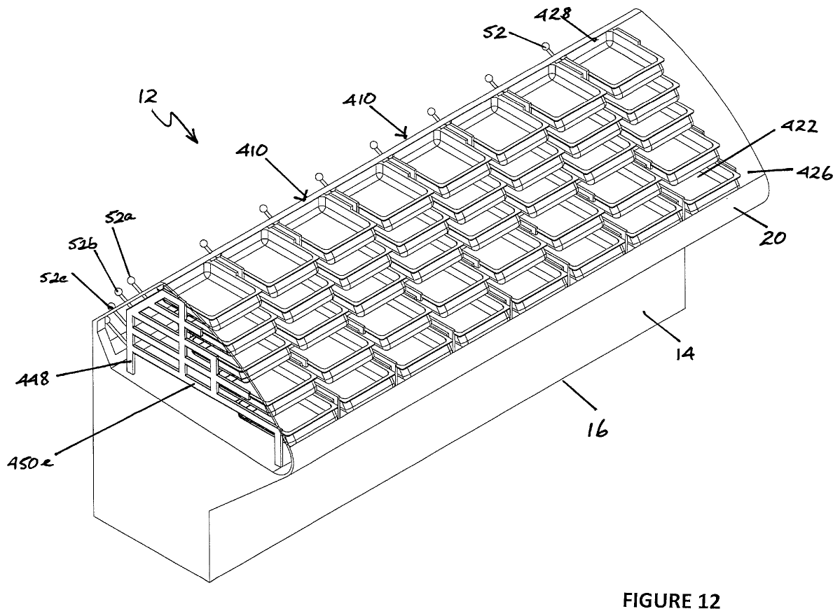

The fourth embodiment in FIGS. 12 to 17 has eight identical versions of apparatus 410 installed in display unit 12, side by side, each apparatus 410 being operable independently.

In this embodiment, apparatus 410 has a frame 448, which differs from frame 48 in the previous embodiment in that trays 422a to 422e are suspended from runners 450a to 450e, respectively. Frame 448 has vertical supports 54, one of which is labelled in FIG. 15.

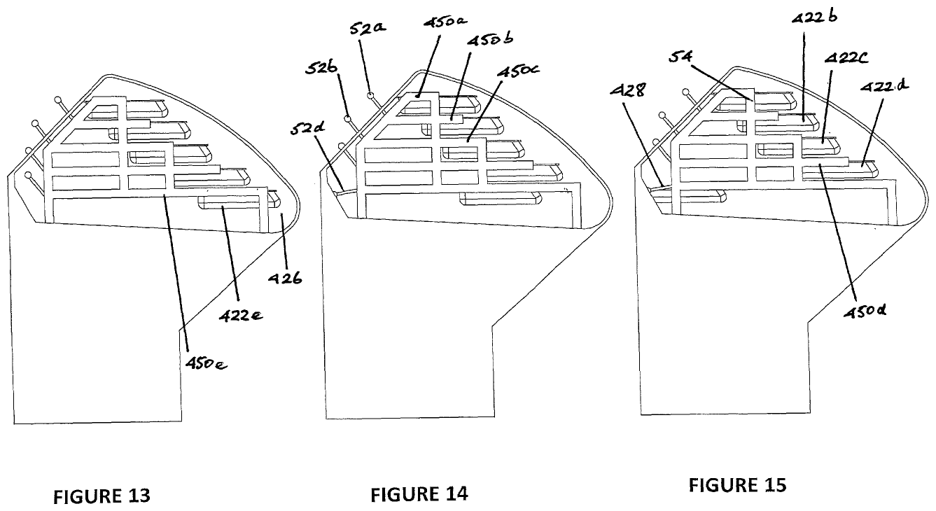

Trays 422a to 422e are moved between first location 426 (FIG. 13) and second location 428 (FIG. 15), using pulley systems activated via handles 52a to 52d respectively.

In FIG. 12, all trays 422 are in first location 426, where their contents are displayed through glass 20. Each tray 422 is movable along a runner 450, operated by a handle 52. There is a set of handles 52a to 52d for each apparatus 410.

### INDUSTRIAL APPLICABILITY

Now that a preferred embodiment of the present invention has been described in some detail, it will be apparent to a skilled person in the art that the apparatus of the present invention may offer at least the following advantages:
1. it enables items to be attractively displayed in a display unit while allowing the retrieval of the items for sale with no or minimum damage or contamination;
2. it reduces or eliminates the danger of one item being dropped or dripped into another item;
3. it reduces or eliminates physiological strain which can occur when a server is bending and extending to manoeuvre an item from the front of a display unit to a serving counter;
4. it may avoid repetitive strain injury caused by the need to reach and pull or push items continuously over the course of a shift;
5. it can facilitate stocking, unstocking and cleaning of display units; and
6. it enhances the display unit, making it more modern and luxurious.
Those skilled in the art will appreciate that the invention described herein is susceptible to variations and modifications other than those specifically described. All such variations and modifications are to be considered within the scope and spirit of the present invention the nature of which is to be determined from the foregoing description.

1. Apparatus suitable for use with a display unit, the display unit having a customer side and a server side, the display unit being adapted to contain a plurality of objects in an inclined or tiered display facing the customer side, the apparatus including conveyor means which is:
adapted to convey a chosen one of the objects in a first direction away from a first location near the customer side to a second location accessible by a server at the server side; and
adapted to convey the object in a second direction from the second location to the first location.

2. The apparatus of claim 1 wherein the conveyor means includes a belt movable by a drive means.

3. The apparatus of claim 2, wherein the drive means includes at least one motor driven supporting wheel.

4. The apparatus of claim 2, wherein the belt has an upper surface of rubber or other material designed to have sufficient friction to retain the object,

5. The apparatus of claim 2, wherein the belt is inclined between the first location and the second location.

6. The apparatus of claim 5, where in the belt is flat at the second location.

7. The apparatus of claim 1, wherein the conveyor means includes lift means adapted to elevate the object above other objects.

8. The apparatus of claim 7, wherein the lift means includes a scissor lift.

9. The apparatus of claim 1, wherein the conveyor means includes a frame having a substantially horizontal runner for conveying the object between the first location and the second location.

10. The apparatus of claim 9, wherein the conveyor means includes lift means adapted to elevate and/or tilt the object.

11. The apparatus of claim 9, which is adapted to convey the object between the first location and the second location by means suspending the object below the runner.

12. The apparatus of claim 1, wherein the apparatus includes a motor or pulley to effect conveying of the object between the first location and the second location.

13. The apparatus of claim 1, which includes stop means to stop the conveyor means when the object reaches the second location.

14. A display unit which includes the apparatus of claim 1.

15. A display unit which includes a plurality of the apparatus of claim 1.
